(19) United States
(12) Patent Application Publication
(10) Pub. No.: US 2009/0037220 A1
(43) Pub. Date: Feb. 5, 2009

(54) Portable medical monitoring and diagnostic system

(75) Inventors: Desmond Chambers, County Galway (IE); Gerard Lyons, County Galway (IE); Michael Madden, County Galway (IE); Michael Schukat, County Galway (IE)

Correspondence Address: THE WEBB LAW FIRM, P.C., 700 KOPPERS BUILDING, 436 SEVENTH AVENUE, PITTSBURGH, PA, 15219, US

(73) Assignee: National University of Ireland Galway, Galway (IE)

(21) Appl. No.: 11/658,629

(22) PCT Filed: Jul. 28, 2004
(86) PCT No.: PCT/IE04/00102

§ 371 Date: Oct. 1, 2008

(51) Int. Cl. G06Q 50/00; G08B 23/00

(52) U.S. Cl. 705/3; 340/573.4

(57) ABSTRACT

A patient care distribution and management system is provided. The system allows for the seamless roaming of a patient within a particular medical facility or between medical facilities. The system includes body area network (BAN) management agents which process data within specified parts of a defined operational remit of a medical facility, a BAN hub agent associated with each patient that communicates with a BAN management agent and stores patient data delivered thereto by medical telemetry monitor diagnostic devices (MTMDDs) connected to each patient. The essential feature of the system is that the BAN hub agent has relatively little processing power compared to the BAN management agent which feeds it with patient monitoring rules to monitor the patient condition and to enable the BAN hub agent to set off alarms etc. as required.

The present invention relates to a method for the collection, analysis and distribution of patient data from a patient stationary or moving within various operational remits of a medical facility to provide patient condition data to patient care staff in accordance with monitoring rules where at least one medical telemetry monitor diagnostic device (MTMDD) is attached to the patient with an associated body area network (BAN) hub agent for the collection and processing of patient diagnostic data when a patient is assigned to one of the operational remits of the medical facility. Further, the invention provides a patient care distribution and management system. Such a specified operational remit, of a medical facility can be one or both of a predetermined geographical area within or outside the medical facility, a transporter moving a patient within or outside the medical facility or indeed a particular patient condition.

It is known, for example, to secure many MTMDD's to a patient and to download information from the MTMDD's to some central processor, to analyse the downloaded data which is then compared with reference sets of measurements to determine whether a patient condition requires medical intervention or not. Indeed, there are many such systems, such as described in U.S. Pat. No. 6,290,646 (Cosentino et al), U.S. Pat. No. 6,443,890 (Geva) and U.S. Pat. No. 6,577,893 (Besson et al). The patents describe how the MTMDD's gather data about a patient's condition and compare it with stored information. The data is obtained from the patient and then analysed remote from the patient. In other patents, such as U.S. Pat. No. 6,221,011 (Bardy), U.S. Pat. No. 6,607,485 (Bardy) and U.S. Pat. No. 6,544,173 (West et al), there is described methods which do not, strictly speaking, actively examine patient data but the patient condition is determined by comparisons with reference sets of measurements or some other expert system rules.

In any of the systems heretofore described, where there is an active “training”, using machine learning or other techniques. This training is carried out within the system leading to very unwieldy, costly and powerful processing equipment being required.

While undoubtedly there are many systems described relating to machine learning for patient diagnostics, heretofore they have not been satisfactory in that the amount of processing required has been inordinate.

A further problem is that, in most facilities, the need to provide the roaming of patients within the facility and information sharing between cooperating facilities has been difficult heretofore. Such roaming may require the handing over as it were the care of the patient from one set of medical personnel to another set. Thus, for example, it is necessary to provide for internal roaming of MTMDD's within a single facility, for example, a patient being moved from an emergency room to a ward or department within the facility. The problem is then to transfer the control of the particular MTMDD from the emergency room to the ward or department and similarly, to monitor the patient, as the patient is being transferred. Exactly the same problems arise, for example, when a patient is being transferred from one medical facility to another, such as by ambulance from one hospital to another hospital. Thus, while the MTMDD's, in many instances, work satisfactorily, they are difficult to manage and organise within the medical facility to support internal roaming and then to promote external roaming beyond the facility. What is needed is a seamless transfer of a patient's care from one set of medical personnel to another set of medical personnel within the same medical facility or between medical facilities, whether physically adjacent or geographically remote.

Further, it is very important to detect when there has been a breakdown in communications between the MTMDD's and the monitoring personnel.

### STATEMENTS OF INVENTION

According to the invention there is provided a method for the collection, analysis and distribution of patient data from a patient stationary or moving within various operational remits of a medical facility to provide patient condition data to patient care staff in accordance with monitoring rules where at least one medical telemetry monitor diagnostic device (MTMDD) is attached to the patient with an associated body area network (BAN) hub agent for the collection and processing of patient diagnostic data and on a patient being assigned to one of the operational remits of the medical facility the method comprising:
defining the diagnostic data to be collected on a separate BAN management agent for the operational remit;
defining initial training monitoring rules to be applied to the diagnostic data to provide patient condition data;
sending from the BAN management agent to the BAN hub agent the initial training monitoring rules and the diagnostic data to be collected to provide the required patient condition data;
collecting diagnostic data at the BAN hub agent and providing patient condition data to the BAN management agent;
collecting for the same diagnostic data patient condition data from patient care staff;
comparing the two sets of patient condition data;
amending, as necessary, the initial training monitoring rules to provide operational monitoring rules; inputting the operational monitoring rules from the BAN management agent onto the BAN hub agent;
continuing in a real-time operational phase to collect new diagnostic data from the MTMDD;
applying the operational monitoring rules to the patient diagnostic data in the BAN hub agent to provide patient care data; and
the BAN hub agent carrying out the necessary communication with the patient care staff having a responsibility assigned to them for the particular patient, having regard to the patient care data produced and the monitoring rules.

There are certain major advantages according to the present invention in that more efficient bed management and more efficient patient care may be achieved. For example, with the present invention it will be considerably easier for departments within the hospital to share beds without the control of the patient transferring from one department to another. It will also be easier for example if the first department or ward in a hospital transfers some of its patients to another ward for that first ward which is ultimately responsible for the patient, to track and monitor the patient's condition. It will greatly facilitate the work flow effectiveness in the hospital and will also allow this flexibility of movement and mobility of patients because the monitoring of the patient's condition will not be affected by the fact that internal roaming is occurring within the hospital. Also when for example a patient has moved from one department in the hospital to another department the original department with that patient's care responsibility residing in them will be able to locate the patient and in the event of an emergency will be able to quickly have the requisite medical attention for that patient.

In one method according to the invention when the processing of some of the patient condition data requires considerable processing capacity, the patient diagnostic data is first sent to the BAN management agent for processing into a form suitable for the BAN hub agent to apply the monitoring rules. The advantage of this is that the BAN hub agent can have relatively little processing power while the BAN management agent can do most of the processing. This is particularly advantageous since generally BAN hub agents will be devices powered by batteries and if too great processing power is required of such BAN hub agents they will continually fail due to lack of power.

Another method according to the invention the patient diagnostic data is downloaded to the BAN management agent from the BAN hub agent for subsequent processing. This means that processing can occur off-line.

In one method according to the invention when on examination of a patient by patient care staff, the patient condition data is downloaded to the BAN hub management agent, the operational monitoring rules are amended, as necessary, and are inputted as new operational monitoring rules into the BAN hub agent to replace the existing rules. This allows for ongoing off-line training.

In one way of carrying out the invention each patient is initially classified as an identified class of patient by patient care staff having regard to the assessment of each patient's medical condition, general physical and other lifestyle characteristics. This allows for a quick choice of various initial training monitoring rules to be made. With this latter method the initial training monitoring rules are chosen having regard to the identified class of that patient.

In one way of carrying out the invention, each patient's diagnostic data and patient condition data are stored by the BAN management agent as they are provided by class of patient and the initial monitoring rules are reviewed and altered over time for each class of patient. By having classifications of patients it is envisaged that in due course many sub-classifications will be devised and a considerable amount of useful data can be stored to facilitate patient care generally.

In another method according to the invention when the communication with the patient care staff requires the issuing of an alarm which is subsequently determined by patient care staff to be a false alarm being spurious, the patient care staff may optionally input to the BAN management agent an alarm suppression for that patient in similar circumstances and then the BAN management agent amends the operational monitoring rules for that patient and inputs the new operational monitoring rules to the BAN hub agent. This allows for the suppression of an alarm for one particular patient because a doctor or other patient care specialist realises that for that particular patient the operational monitoring rules require adjustment.

In another method according to the invention when the communication with the patient care staff requires the issuing of an alarm which is subsequently determined by patient care staff to be a false alarm being spurious, the patient care staff may optionally input to the BAN management agent a shared alarm suppression for that class of patient in similar circumstances and then the BAN management agent amends the monitoring rules for that class of patient and inputs the amended monitoring rules to the BAN hub agents of that class of patient. In this way groups or classes of patients may have their operational monitoring rules altered so as to prevent a large amount of false alarms.

In another embodiment of the invention on a false alarm being raised and no input is received from the patient care staff the patient diagnostic data and patient condition data are stored in the BAN management agent for subsequent analysis and possible revision of the operational monitoring rules by patient care staff off-line. This is particularly advantageous because it must be appreciated that very often patient care staff can be very busy. There can, for example be a crisis occurring in a particular ward or medical facility and when a false alarm is raised the patient care staff don't have time to do any work on the false alarm but simply to delete that spurious alarm and carry on with the more important work required. This, however, allows such data to be stored off-line and subsequently to be considered and possibly used to change the operational monitoring rules.

In another method according to the invention on a patient and BAN hub agent moving from a first operational remit of a medical facility to a second operational remit, the new second BAN management agent of the second operational remit contacts the first BAN management agent of the first operational remit and downloads the relevant data and monitoring rules for subsequent use. This allows roaming between and within the facility. On a modification of this method on downloading the operational monitoring rules, the second BAN management agent reviews and amends, as appropriate, the operational monitoring rules having regard to the characteristics of its operational remit.

One method according to the invention, the BAN management agents download data to other BAN management agents for use by all the BAN management agents.

In one method of carrying out the invention on a patient and BAN hub agent moving from the operational remit of a first medical facility to that of another second medical facility the first medical facility sends all relevant patient data to the second medical facility. This facilitates roaming between various facilities and could for example facilitate the transfer of a patient from a hospital in one city to a hospital in another.

In accordance with one method of the invention the BAN management agent senses and stores the physical location of the BAN hub agent for ease of location. This can be of vital importance to patient care staff in the sense that they know where all their patients are such that if an emergency arises the patient can be quickly located or indeed if the patient is simply required for routine examination the medical care staff can quickly locate the patient and make the necessary decision regarding examination.

In another method according to the present invention on a breakdown of communications between the BAN hub agent and the BAN management agent one or more of the steps of:
causing an alerting alarm at the BAN hub agent;
causing an alerting alarm at the BAN management agent;
causing an alerting alarm for those patient care staff having a responsibility assigned to them for that particular patient; and
re-establishing communications by way of an alternative standby communications system, are carried out.

This is most important as one of the biggest problems with many of the wireless communications now being used more extensively in medical facilities is the fact that communications can break down for relatively simple reasons. Therefore it is vital that patient care staff be aware that the particular patient is out of communications. It also may be very important that they know exactly where the patient is located as the location may make it obvious to the patient care staff why communication has broken down. But it is also very important to be able to have some way of restoring the communications or if not of restoring it causing an alerting alarm to be raised.

According to the invention there is provided a patient care distribution and management system comprising:
a plurality of medical facility agents each having means to provide information relating to patients within a defined operational remit of a medical facility;
a medical facility registry having, means to allow individual medical facility agents to identify, locate and interact with other medical facility agents;
body area network (BAN) management agents for the collection and management of data within specified parts of the defined operational remit;
a BAN hub agent associated with one patient for communication with a BAN management agent and for the storage and processing of patient data;
medical telemetry monitor diagnostic devices (MTMDD) for connection to each patient for the collection and delivery of patient data to each BAN hub agent;
monitor agents for communication with each BAN management agent for use by patient care staff to receive and transmit information relevant to the BAN hub agent of a specific patient;
communication means for connecting the medical facility registry with the medical facility agents the medical facility agents with the BAN management agents and the BAN management agents with the BAN hub agents and the monitor agents; and
communications transfer means for connecting a BAN hub agent to a second BAN management agent on moving from the operational remit of a first BAN management agent to the operational remit of the second BAN management agent.

This facilitates the seamless roaming of a patient within a particular medical facility between the various smaller facilities making up that major medical facility.

In one embodiment of the invention communication transfer means comprises:
a physical sensor to detect the presence of the BAN hub agent in a defined operational remit;
a network broadcast mechanism; and
means to identify the BAN management agent associated with the operational remit.

It is very important to have reliable means to locate patients and to identify the necessary BAN management agents associated with the operational remit.

In a further embodiment of the invention there is provided a system in which the monitor agents associated with the BAN management agent are adapted to receive communications relating to some or all of the patients within the part of the defined operational remit associated with the BAN management agent. This greatly facilitates the work for patient care staff.

In another embodiment of the invention means are provided to detect the breakdown in communications between the BAN hub agent and the BAN management agent said means causing one of the following:
an alerting alarm at the BAN hug agent;
an alerting alarm at the BAN management agent;
an alerting alarm at, at least some of the monitor agents; and
the initiating of an alternative standby communications system.

This is particularly important so that patient care staff will be alerted when communications with a particular patient have been terminated. In certain instances it may be of relatively little importance, in others it may be very important.

In another system according to the invention each BAN management agent comprises processing means for the reception and processing of patient diagnostic data from the BAN hub agents; data from the monitor agents and other relevant data to provide monitoring rules for mapping patient data to provide patient diagnostic data and for transmitting the monitoring rules to each BAN hub agent within the defined operational remit of the BAN management agent and in which each BAN hub agent comprises processing means for reception of the patient data and for applying the monitoring rules to the patient data to provide the required patient condition data. This allows for the clear separation of the processing between the BAN management agent and the BAN hub agents thus ensuring that you can have BAN hub agent of relatively low processing power with a BAN management agent of as much processing power as is required.

In a further embodiment of the invention each BAN management agent has processing means comprising means for the reception of patient operational monitoring rules from a first BAN hub agent on the BAN hub agent and patient moving to the operational remit of that second BAN hub agent and to modify the operational monitoring rules having regard to the operational remit of the second BAN hub agent. It has to appreciated that one might have much more stringent operational monitoring rules for a patient when they're, for example, in intensive care than when they are in recovery and thus it is necessary that the operational monitoring rules change as the patient comes under as it were the care of a different BAN management agent because that BAN management agent may have a different operational remit than the previous BAN management agent dealing with that specific patient.

### DETAILED DESCRIPTION OF THE INVENTION

The invention will be more clearly understood from the following description of some embodiments thereof, given by way of example only, with reference to the accompanying drawings, in which:

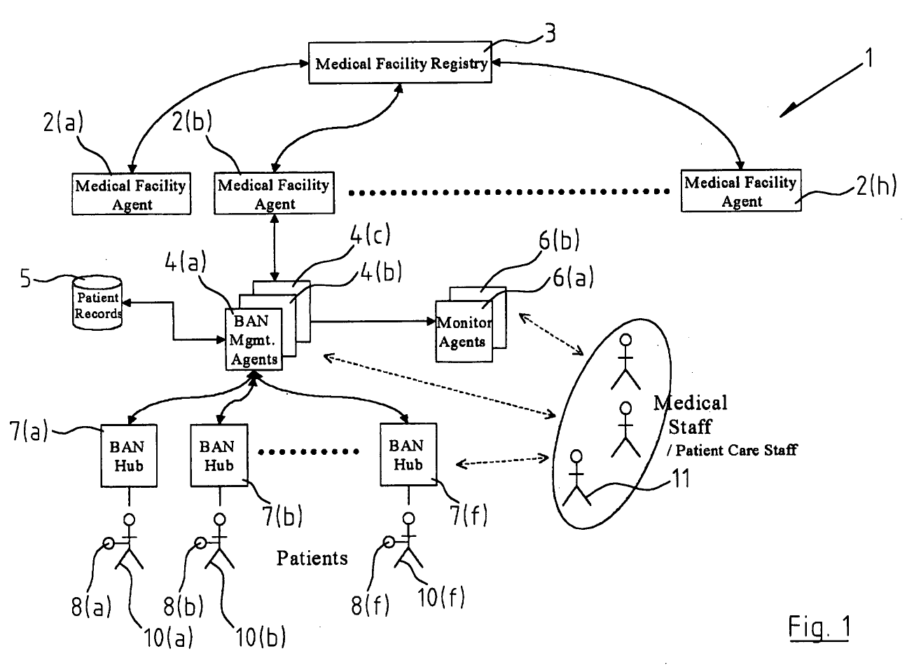

FIG. 1 is a stylised diagrammatic view of the system,

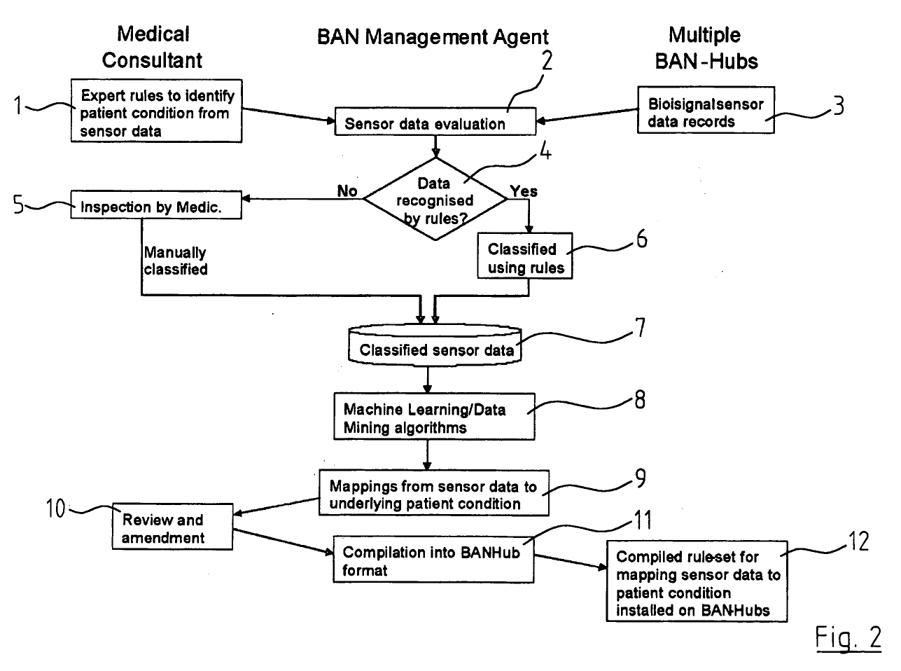

FIG. 2 is a flow chart illustrating a training phase,

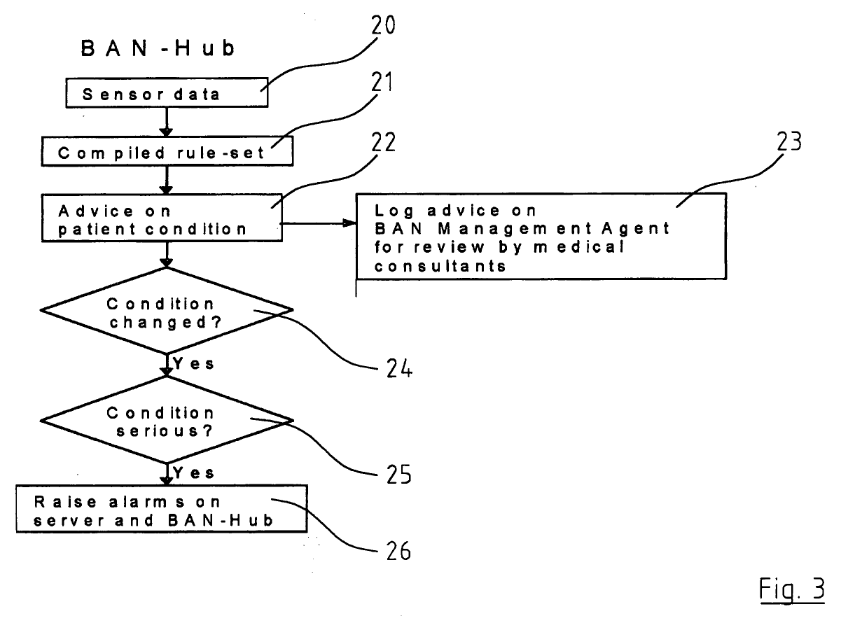

FIG. 3 is a flow chart illustrating one aspect of the invention, and

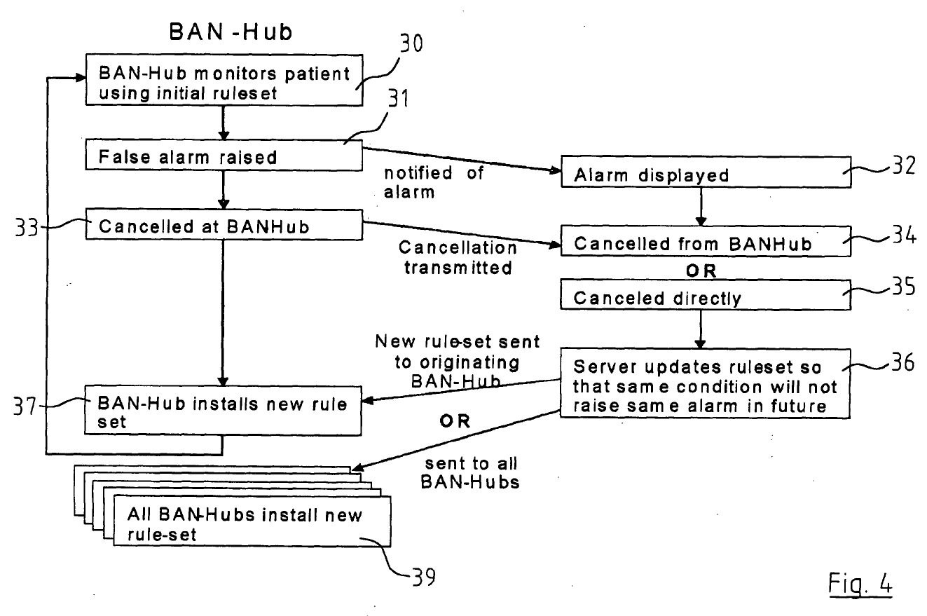

FIG. 4 is a flow chart illustrating alarm suppression.

In this specification the term operational remit is used to define the area of responsibility of for example a particular department within a hospital. Such an area could for example be a specified geographical location within a medical facility namely the actual department itself, it could be a transporter for moving a patient around the faculty such as for example hospital trolleys where there would be a department of porters etc., it could be an ambulance for moving the patient out of one hospital to another in which case the medical facilities would be the two hospitals and the area of responsibility of each hospital might be defined by a geographical area, but the ambulance in turn would have an operational remit for the patient, similarly it could be an unspecified geographical location external of a medical facility. Finally, it could be simply a more broad treatment-based operational remit namely a particular patient, or indeed all those patients having a particular medical condition. For example, within a hospital you might have a cardiac department which would be responsible for all cardiac patients within the whole hospital. Thus the situation could possibly arise where more than one medical facility within a hospital had an operational remit that overlapped. For example, and still dealing with a cardiac patient, you might have a department within the hospital that was responsible for everybody within the hospital but also might share or indeed abrogate that responsibility to, for example, the cardiac department.

Referring to the drawings and initially to FIG. 1, there is illustrated a distribution and management system for portable medical telemetry and diagnostic devices, indicated generally by the reference numeral 1. The system (1) is illustrated for a number of medical facilities, each having a medical facility agent 2(a) to 2(h). Subscript letters are not used in the description unless when required to distinguish between units. A medical facility registry (3) is associated with the medical facility agents 2(a) to 2(h). The medical facility could be a whole hospital, and thus each of the medical facility agents represents the hospital. Equally the medical facility could be a division or centre within a hospital. Thus, in this description, the medical facility agents 2(a) to 2(h) are each associated with relatively large departments within the hospital. In turn, associated with each medical facility agent, and only shown for medical facility agent 2(b), is a number of body area network (BAN) management agents 4(a), 4(b) and 4(c) which would represent part of the defined operational remit of each medical facility agent. For example, as stated above, they might be wards within a specific department or might indeed be, for example ambulances within a transport department or organisation which would be represented by that medical facility agent 2. These BAN management agents 4 are, in turn, connected to a patient record database 5, monitor agents 6(a) and 6(b) and BAN hub agents 7. The BAN management agent 4(a) is shown connected to the BAN hub agents 7(a) to 7(f). The monitor agents 6 are devices such as hand-held devices that will be available to medical personnel but could, for example, be fixed computers or the like, at desks or other stations.

Each BAN hub agent 7 is connected to MTMDD's B which are connected to patients. The patients are identified by the reference numeral 10 and subscript letters, and the patient care staff, by the reference numeral 11.

The medical facility registry 3 is essentially a high level binding mechanism which as explained already, could be for the one large hospital, could be for a series of hospitals or could be for a specific geographical medical area to identify which MTMDD 8 is attached to which patient 10 and to which BAN hub agent 7. The medical facility registry 3 is essentially a trading server to allow participants in the system identify and find each other and set up agreements between each other such as for the handover of patients. When, in this specification, the term “operational remit” is used, it could be, as stated already, a strictly defined geographical operational remit such as a particular department, it could be a loosely defined operational remit such as that covered by a medical practice, these might overlap geographically but would not necessarily overlap in the patients they attended to.

Generally, as stated these medical facility agents represent a particular medical facility within the overall architecture. It could, for example, be a particular department in a hospital, it could, in certain circumstances, be a hospital itself or it could, for example, be the ambulance department which would have a number of ambulances in it.

Before describing the invention in detail, it is advantageous to describe a general overview of the system.

As explained already, the medical facility registry 3 can be associated with one hospital, a group of hospitals, a geographical area, for example, all the medical care staff within a specific area, and so on. However, it is easier to describe it by way of being the operational core for the one hospital which forms a number of medical facilities. The medical facility registry 3 has a central processing unit which defines the interaction protocol of the various medical facilities within that particular hospital such as, for example, other departments. It includes all the legal terms, security programmes and ontology for sharing information between the various parts in medical facilities of that hospital and in turn, with other medical facilities. It will include means for the registration of facility identifiers and capabilities. It is thus a distributed service that can be replicated in other medical facilities. As illustrated, the medical facility registry 3 is connected to a number of medical facility agents each one representing the one medical facility. Its primary purpose is to ensure that the various medical facility agents can interact with each other.

Essentially, the medical facility agents represent the particular medical facility within the overall architecture and the primary role of the medical facility agent is to enable the external roaming and migration of the MTMDD's between different facilities. These agents have means to register with and to locate each other using the medical facility registry as the central binding mechanism. In one embodiment, they provide network accessible interface that name facilities and publish information about the facility, as well as the level of roaming and information sharing available to an MTMDD trying to migrate from another cooperating medical facility operational remit associated with a different medical facility agent. The purpose is to provide support for internal roaming of the MTMDD's within the particular operational remit.

The BAN management agents 4 are essentially the core of the operation in that they are processors for the collection and management of data within specified parts of the defined operational remit which is governed by or associated with one particular medical facility agent 2. Each BAN management agent 4, as stated already, communicates directly with the monitor agents 6 which can be handled by the staff and with the BAN hub agents 7 within that part of the defined operational remit associated with the BAN management agent 4.

Each BAN management agent 4 manages and collects data from a group of BAN hub agents 7 within the specified part of the defined operational remit such as, for example, a single ward or department within a larger department associated with one of the medical facility agents. It actually acts as a server for a number of BAN hub agents 7. The BAN management agent 4 has the processing power to carry out these tasks, as will be described hereinafter.

Each monitor agent 6 interfaces with the BAN management agent 4 and the patient records, namely, the database 5 and can be used to download information regarding patients to the BAN management agent 4 or simply to transfer information from the BAN management agent 4 to the medical personnel. As explained already, this can be anything from a PC to a hand-held device or PDA.

The BAN hub agent 7 is the central connector or hub for various biomedical sensors, namely, the MTMDD's connected to a particular patient. They can be connected to the BAN hub agent 7 by either a wired or wireless interface. Generally, the BAN hub agent 7 can receive diagnostic routines and perform local pre-processing/diagnostics on acquired bio-signals in real-time. This is described in more detail below.

While the operation of the invention is described in more detail below, essentially the system is such that the BAN management agent 4 carries out any necessary processing of information received from any BAN hub agent 7 and then downloads to the BAN hub agent 7, rules and data for the analysis of signals and data received from the MTMDD's associated or connected to that BAN hub agent 7. The BAN hub agent 7 is therefore a relatively low powered low capacity device. It's advantage is that it also has rules and structures built in such that, for example, when it receives some data from an MTMDD 8, it is capable of taking the necessary action such as, for example, the issuing of an alarm, the downloading of information or whatever is necessary, having regard to the signal or data transmitted by the particular diagnostic device. Thus, in simplest terms, the BAN hub agent 7 has sufficient information to ensure that the condition of the patient is monitored accurately and can be transmitted. For example, in one embodiment of the invention, the BAN hub agent 7, when it cannot transmit via its normal communications network, with the BAN management agent 4, it is envisaged that it can be adapted to either itself issue some form of warning, such as an audible warning, or can directly transmit information to monitor agents 6. It is envisaged that means may be provided to detect the breakdown of the communication between the BAN hub agent 7 and the BAN management agent 4 to cause an alerting alarm at the BAN hub agent 7, an alerting alarm at the BAN management agent 4 an alerting alarm at, at least some of the monitoring agents 6 and the initiation of an alternative standby communication system. Some or all of these may be carried out and the means may be provided either on the BAN management agent 4 or the BAN hub agent 7 as is appropriate.

There is provided communications transfer means in the BAN management agent 4, such that when a BAN hub agent 7 moves out of the part of the defined operational remit controlled by that BAN management agent 4, the BAN hub agent 7 is transferred to the care of another BAN management agent 4, namely when the BAN hub agent 7 is effectively moving from the specified part of the defined operational remit of the first BAN management agent 4 to the defined operational remit of another BAN management agent 4. Effectively this facilitates internal roaming within the particular medical facility or more importantly within the operational remit of that medical facility namely in the present example the particular hospital whose operational remit might also include as has been explained above ambulance under the hospital's care and control.

It is envisaged that each BAN management agent 4 will, in some way, be associated with sensors which will allow it to sense the presence of a BAN hub agent 7 within it's operational remit. This, for example, could simply be fixed sensors on the exits and entrances to a department, a GSM device attached to a hub agent, and indeed could be any form of sensor. Indeed any network broadcast mechanism could be used. Further, the BAN hub agent 7 will have means, when moving out of the defined operational remit of all the facility agents of one medical facility, that is to say, out of the hospital connected to the medical registry, to communicate via that medical facility registry with a totally separate medical facility of another patient care system or indeed of the same patient care system, to transfer the patient data, the BAN hub agent 7 and the patient to the care of, that other patient care system.

It will be appreciated that the monitor agents 6 associated with the BAN management agents 4 are adapted to receive communications relating to some or all of the patients within the part of the defined operational remit associated with that BAN management agent 4.

As explained already, the BAN hub agent 7 is used to determine the patient's current condition in real time by examining the data coming from the medical sensors, namely the MTMDD's 8. Various techniques for this will be described hereinafter, however, it is important to note that the BAN hub agent 7 does not perform machine learning or data mining itself on the diagnostic data. This operation is located on the BAN management agent 4. The BAN management agent 4 carries out training and operational phases, as described below. However, the training phase happens off-line in the BAN management agent 4, whereas the operational phase happens on-line, that is to say, in real-time on the BAN hub agent 7. This is an essential feature of the present invention. While the real-time analysis of the patient's condition that is performed on the BAN hub agent 7 will have its input as a set of biosensor signal readings i.e. diagnostic data from the MTMDD's 8, the actual monitoring rules, as it were, that will determine the patients condition, will be downloaded to the BAN hub agent 7 from the BAN management agent 4. Effectively, therefore, to a certain extent, the BAN hub agent 7 is an operating device but not, as has been envisaged heretofore, one that carries out excessive processing or analysis, but simply receives sufficient information from the BAN management agent 4 to allow it operate as if it had that processing power.

This is one of the essential features of the invention namely the use of a relatively low powered BAN hub agent. It is envisaged that where some diagnostic data received by the BAN hub agent 7 would require inordinate processing time, the BAN hub agent 7 will transmit the diagnostic data to the BAN management agent 4 which will process the data and then download the result of that processing to the BAN hub agent 7. The BAN hub agent 7 will then carry out the necessary action as required. It will be appreciated that the BAN hub management agent 4 will have considerable processing power or indeed may in certain circumstances share processing power with other BAN management agents by having access to a separate more powerful processor such as a large main-frame computer.

Dealing firstly with the BAN management agent 4 and the training phase, reference is made to FIG. 2. What one does is, before a patient is being monitored, one has a set of rules namely initial training monitoring rules. These are expert rules to identify a patient's condition from sensor data. These rules will have already been inserted into the BAN management agent 4 and possibly into another server. These monitoring rules are effectively the diagnostic data evaluation rules. Thus, in step 1, initial training monitoring rules are provided and then in step 2, these are inputted as rules for sensor data evaluation. These would be standard rules, as it were, for the evaluation of a patient's condition, however, they would not necessarily be sufficient to fully monitor a particular patient. Then, during the training phase, step 4 takes place, namely, the first thing to be queried is whether the data is recognised by the rules. In other words, does the data conform exactly to a rule already produced. This is probably highly unlikely in many cases because what has been done is to try to adapt the rules to the particular patient so that, almost certainly, all the data will not be recognised and therefore, in step 5, it will be examined by a patient care staff member or members. However, if it were to have been recognised, then in step 6, it will be classified using the rules and again entered effectively into the BAN management agent 4 in step 7. However, if, as is likely, it is not specified by the rules, then they will be inspected by a medical practitioner or another expert in step 5 and this will then be manually classified. Step 7 will then be repeated. Then, various learning mining algorithms will be used in step 8 so as to provide, in step 9, mappings from the diagnostic data to give an idea of the patient condition. These would generally be reviewed in step 10 and then in step 11, in this particular embodiment, they will be compiled into a suitable format for downloading onto a BAN hub agent 7 as operational monitoring rules. Then, in step 12, the operational monitoring rules will be installed on the BAN hub agent 7. Essentially what the patient care staff do is to amend as necessary the initial training monitoring rules to provide these operational monitoring rules.

It will be appreciated that various artificial intelligence (AI) techniques may be used such as:
expert-type rules formulated by human experts
mappings from sensor data vectors to corresponding patient conditions, that are constructed automatically (or semi-automatically) using classification algorithms; these could be in the form of explicit rules or in an implicit form such as a trained neural network or Bayesian classifier.

Indeed, various other statistical techniques for data mining might be used.

Generally, however, in the training phase, expert rules will be supplied by medical consultants and will be manually codified in an appropriate form. Generally, the biosignal sensor data in the diagnostic data is transmitted from the multiple BAN hub agents 7 to the BAN management agent 4 where it is stored in a form equivalent to that of the BAN hub data repository. It will be appreciated that any technique may be used, anything from Decision Trees (e.g. C4.5); logic-based learners (e.g. FOIL); neural networks (e.g. Feed-forward NN trained with the Backpropagation algorithm); Bayesian Network learners (e.g. K2). The learning techniques themselves are obviously standard.

Depending on the way the monitoring rules come out, they may or may not be reviewed by a medical practitioner i.e. patient care staff. The whole point is that this is a training phase and when it is first done, then operational monitoring rules are provided. However, during the operation phase, the operational monitoring rules will be again reviewed and reconsidered by the patient care staff. Thus, there is a continuous off-line training phase that may take place, either continuously or at predetermined defined times. In one way of carrying out the invention each patient is initially classified as an identified class of patient by patient care staff having regard to the assessment of each patient's medical condition, general physical and other lifestyle characteristics. It is by such a classification that the appropriate rule, mock operational monitoring rules and the diagnostics data required to provide those operational monitoring rules can be achieved. Thus the initial training monitoring rules would be chosen having regard to the identified class of that patient. It is envisaged that each patient's diagnostic and patient condition data will be stored by the BAN management agent 4. They may be provided by class of patient and over time the initial monitoring rules are reviewed and altered for each class of patient as described hereinafter.

Referring now to FIG. 3, there is illustrated how the invention will operate at the BAN hub agent 7. The latest version of the operational monitoring rules is sent to the BAN hub agent 7 which stores it, to replace the previous version. The diagnostic data is received from the MTMDD's in step 20 and it is inputted to the compiled operational monitoring rule set, in step 21, that has already been received. This then provides the necessary advice i.e. patient condition data, in step 22. The patient condition, as provided by the patient condition data can be logged onto the BAN management agent 4 for review by medical consultants or other personnel, that is presuming there is nothing particular wrong.

However, as well as this, in step 23, the data is compared to the compiled operational monitoring rule set and checked as to whether the patient condition data has changed in step 24. Obviously, if the patient condition as evidenced by the patient condition data has not changed, nothing further happens and the step of logging the device, namely, step 23 takes place and nothing further is required. If, however, the patient condition has changed, then the operational monitoring rule and its resultant patient condition data is compared again with previous patient condition data. In step 25, it is queried as to whether the change in patient condition is such as to render it serious and if it is, then in step 26, the necessary alarms are raised.

It will be noticed, however, that the great advantage of this present invention is that the BAN hub agent 7 does not just simply download the data but it actually carries out sufficient monitoring to determine the patient condition. It can do this because of the way in which so much of the processing is carried out on the BAN management agent 4.

Referring now to FIG. 4, there is illustrated how a shared false alarm suppression facility is provided. It is a well known difficulty with medical monitoring devices that raised alarms to alert the physician of the patient's problem is the “cry wolf” dilemma, in the sense that the devices follow a conservative strategy of raising false alarms i.e. spurious alarms rather than risking a situation arising where a patient requires attention but no alarm is raised. It can happen that the physician may end up ignoring all of the alarms because so many of them are false. One of the problems with the present way of suppressing alarms or indeed of raising alarms is that not enough care is taken of the situations in which the alarms can arise and in particular, where false alarms can arise. It is too easy to simply say it was a false alarm and do nothing about it. Obviously, if a patient is in an intensive care unit, much more care is taken in the sense that any deviation from a condition may require an alarm to be raised, while if a patient is already recovering, then what one does not want to do is to have, for example, alarms raised regarding a patient's condition when the patient is actually taking exercise when various sensed conditions might change considerably. What needs to be done is firstly, to ensure that for particular patients, when an alarm is raised, that it be attended to but if it is found that it is actually a false alarm, rather than simply suppressing it, some further action is taken. As mentioned already, if it is determined that a patient's condition is sufficiently serious (see step 25 of FIG. 3), then an alarm is raised at the BAN hub agent 7 or at the BAN management agent 4. Indeed, it is well known, for example, to have means for suppressing an individual alarm at an agent, however, what has not been done in previous systems is to allow the suppression of that alarm condition as it were, in other words, to ensure that alarm is cancelled in the future for the same patient in the same circumstances if that is appropriate.

Referring now to FIG. 4, the BAN hub agent 7 monitors a patient using a rule set i.e. operational monitoring rules in step 30 and then in step 31, a false alarm is raised. The alarm is displayed on the BAN management agent 4 and on some monitor agents 6. Then the alarm, having been displayed in step 32, in step 33, will be cancelled after hopefully examination of the patient by medical personnel on the BAN hub agent 7 which will then deliver that alarm cancellation which will be transmitted from the BAN hub agent 7 in step 34, to the BAN management agent 4. Indeed, it may have been cancelled directly by a direct message by the medical personnel to the BAN management agent 4 in step 35. In step 36, the operational monitoring rules are updated and either directly installed in step 37 on the BAN hub agent 7 or may alternatively be sent for installation on all BAN hub agents 7, if it is felt by the medical personnel that this is a rule that should be generally applied.

However, it will be appreciated that in certain instances particularly in emergencies or when patient care staff are under extreme work pressures the medical person might just simply on examination of the patient delete the false alarm as happens regularly at present. However, in accordance with the present invention when such an event takes place the patient diagnostic data and the patient condition data derived therefrom which caused the spurious or false alarm are stored in the BAN management agent 7 for subsequent analysis and possible revision of the operational monitoring rules by the patient care staff off-line. It will be appreciated that this is particularly advantageous as it allows the review of all false alarms which were not attended to by the patient care staff beyond simply cancelling them.

What has to be appreciated with the present invention is that it is not limited to any particular rules or any particular artificial intelligence (AI) rules or other work. It is provided to make these easier to operate. There is an initial training, then an ongoing training during operation of the invention and while some of this may have been done heretofore in various artificial intelligence systems, it has not been done in such a way as to allow the monitoring to be carried out in an efficient manner. It may be advantageous to have the training carried out, as it were, off-line with access to data from many BAN hubs. This may in fact be done by a separate server, rather than the BAN management agent. The great advantage is that the training can benefit from having large amounts of processing power, as there is a large amount of data to derive simple mapping rules, whereas the operation does not require large computational resources to apply the rules.

It is also envisaged that any extension of machine learning techniques may be used in relation to alarm suppression.

It will be appreciated that the various agents and devices used in the present invention may be provided with all the various processing means required to carry out the invention. It will further be appreciated that the term “agent” is not used just simply in its normal context to denote hardware or usually software-based computer system or device that enjoys the properties of autonomy, social ability, reactivity, proactivity, temporal communication and goal orientedness. They are also in this specification intended to cover what could be best described as stronger definitions or concepts of an agent which will be a computer system that in addition to having the former properties is either conceptualised or implemented using concepts that are more usually applied to humans. Therefore, in the present invention the term agent can be applied to a wide range of entitles including the software systems which act on behalf of other entities in an autonomous fashion, perform this action with some level of proactivity and/or reactiveness and exhibit some level of the key attributes of learning, co-operation and mobility.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiment hereinbefore described, but may be varied in both construction and detail within the scope of the claims.

1. A method for the collection, analysis and distribution of patient data from a patient stationary or moving within various operational remits of a medical facility to provide patient condition data to patient care staff in accordance with monitoring rules where at least one medical telemetry monitor diagnostic device (MTMDD) is attached to the patient with an associated body area network (BAN) hub agent for the collection and processing of patient diagnostic data and on a patient being assigned to one of the operational remits of the medical facility the method comprising:
defining the diagnostic data to be collected on a separate BAN management agent for the operational remit;
defining initial training monitoring rules to be applied to the diagnostic data to provide patient condition data;
sending from the BAN management agent to the BAN hub agent the initial training monitoring rules and the diagnostic data to be collected to provide the required patient condition data;
collecting diagnostic data at the BAN hub agent and providing patient condition data to the BAN management agent;
collecting for the same diagnostic data patient condition data from patient care staff;
comparing the two sets of patient condition data;
amending, as necessary, the initial training monitoring rules to provide operational monitoring rules;
inputting the operational monitoring rules from the BAN management agent onto the BAN hub agent;
continuing in a real-time operational phase to collect new diagnostic data from the MTMDD;
applying the operational monitoring rules to the patient diagnostic data in the BAN hub agent to provide patient care data; and
the BAN hub agent carrying out the necessary communication with the patient care staff having a responsibility assigned to them for the particular patient, having regard to the patient care data produced and the monitoring rules.

2. A method as claimed in claim 1, in which when the processing of some of the patient condition data requires considerable processing capacity, the patient diagnostic data is first sent to the BAN management agent for processing into a form suitable for the BAN hub agent to apply the monitoring rules.

3. A method as claimed in claim 1, in which the patient diagnostic data is downloaded to the BAN management agent from the BAN hub agent for subsequent processing.

4. A method as claimed in claim 1, in which on examination of a patient by patient care staff, the patient condition data is downloaded to the BAN hub management agent, the operational monitoring rules are amended, as necessary, and are inputted as new operational monitoring rules into the BAN hub agent to replace the existing rules.

5. A method as claimed in claim 1, in which each patient is initially classified as an identified class of patient by patient care staff having regard to the assessment of each patient's medical condition, general physical and other lifestyle characteristics.

6. A method as claimed in claim 5, in which the initial training monitoring rules are chosen having regard to the identified class of that patient.

7. A method as claimed in claim 5, in which each patient's diagnostic data and patient condition data are stored by the BAN management agent as they are provided by class of patient and the initial monitoring rules are reviewed and altered over time for each class of patient.

8. A method as claimed in claim 1, in which when the communication with the patient care staff requires the issuing of an alarm which is subsequently determined by patient care staff to be a false alarm being spurious, the patient care staff may optionally input to the BAN management agent an alarm suppression for that patient in similar circumstances and then the BAN management agent amends the operational monitoring rules for that patient and inputs the new operational monitoring rules to the BAN hub agent.

9. A method as claimed in claim 5, in which when the communication with the patient care staff requires the issuing of an alarm which is subsequently determined by patient care staff to be a false alarm being spurious, the patient care staff may optionally input to the BAN management agent a shared alarm suppression for that class of patient in similar circumstances and then the BAN management agent amends the monitoring rules for that class of patient and inputs the amended monitoring rules to the BAN hub agents of that class of patient.

10. A method as claimed in claim 8, in which on a false alarm being raised and no input is received from the patient care staff the patient diagnostic data and patient condition data are stored in the BAN management agent for subsequent analysis and possible revision of the operational monitoring rules by patient care staff off-line.

11. A method as claimed in claim 1, in which on a patient and BAN hub agent moving from a first operational remit of a medical facility to a second operational remit, the new second BAN management agent of the second operational remit contacts the first BAN management agent of the first operational remit and downloads the relevant data and monitoring rules for subsequent use.

12. A method as claimed in claim 11 in which, on downloading the operational monitoring rules, the second BAN management agent reviews and amends, as appropriate, the operational monitoring rules having regard to the characteristics of its operational remit.

13. A method as claimed in claim 1, in which the BAN management agents download data to other BAN management agents for use by all the BAN management agents.

14. A method as claimed in claim 1, in which on a patient and BAN hub agent moving from the operational remit of a first medical facility to that of another second medical facility the first medical facility sends all relevant patient data to the second medical facility.

15. A method as claimed in claim 1, in which the BAN management agent senses and stores the physical location of the BAN hub agent for ease of location.

16. A method as claimed in claim 1, in which on a breakdown of communications between the BAN hub agent and the BAN management agent one or more of the steps of:
causing an alerting alarm at the BAN hub agent;
causing an alerting alarm at the BAN management agent;
causing an alerting alarm for those patient care staff having a responsibility assigned to them for that particular patient; and
re-establishing communications by way of an alternative standby communications system, are carried out.

17. A patient care distribution and management system comprising:
a plurality of medical facility agents each having means to provide information relating to patients within a defined operational remit of a medical facility;
a medical facility registry having means to allow individual medical facility agents to identify, locate and interact with other medical facility agents;
body area network (BAN) management agents for the collection and management of data within specified parts of the defined operational remit;
a BAN hub agent associated with one patient for communication with a BAN management agent and for the storage and processing of patient data;
medical telemetry monitor diagnostic devices (MTMDDs) for connection to each patient for the collection and delivery of patient data to each BAN hub agent;
monitor agents for communication with each BAN management agent for use by patient care staff to receive and transmit information relevant to the BAN hub agent of a specific patient;
communication means for connecting the medical facility registry with the medical facility agents, the medical facility agents with the BAN management agents, and the BAN management agents with the BAN hub agents and the monitor agents; and
communications transfer means for connecting a BAN hub agent to a second BAN management agent on moving from the operational remit of a first BAN management agent to the operational remit of the second BAN management agent.

18. A system as claimed in claim 17, in which the communications transfer means comprises:
a physical sensor to detect the presence of the BAN hub agent in a defined operational remit;
a network broadcast mechanism; and
means to identify the BAN management agent associated with the operational remit.

19. A system as claimed in claim 17, in which the monitor agents associated with the BAN management agent are adapted to receive communications relating to some or all of the patients within the part of the defined operational remit associated with the BAN management agent.

20. A system as claimed in claim 17, in which means are provided to detect the breakdown in communications between the BAN hub agent and the BAN management agent, said means causing one of the following:
an alerting alarm at the BAN hub agent;
an alerting alarm at the BAN management agent;
an alerting alarm at, at least some of the monitor agents; and
the initiating of an alternative standby communications system.

21. A system as claimed in claim 17, in which each BAN management agent comprises processing means for the reception and processing of patient diagnostic data from the BAN hub agents, data from the monitor agents and other relevant data to provide monitoring rules for mapping patient data to provide patient diagnostic data and for transmitting the monitoring rules to each BAN hub agent within the defined operational remit of the BAN management agent and in which each BAN hub agent comprises processing means for reception of the patient data and for applying the monitoring rules to the patient data to provide the required patient condition data.

22. A system as claimed in claim 21, in which each BAN management agent has processing means comprising means for the reception of patient operational monitoring rules from a first BAN hub agent on the BAN hub agent and patient moving to the operational remit of that second BAN hub agent and to modify the operational monitoring rules having regard to the operational remit of the second BAN hub agent.
